(19) United States
(12) Patent Application Publication
(10) Pub. No.: US 2019/0180389 A1
(43) Pub. Date: Jun. 13, 2019

(54) ANALYSING ENERGY/UTILITY USAGE

(71) Applicant: LIVERPOOL JOHN MOORES UNIVERSITY, Liverpool, Merseyside (GB)

(72) Inventors: William Hurst, Liverpool Merseyside (GB); Carl Chalmers, Liverpool Merseyside (GB); Michael Mackay, Liverpool Merseyside (GB); Paul Fergus, Liverpool Merseyside (GB)

(21) Appl. No.: 16/322,217

(22) PCT Filed: Jul. 31, 2017
(86) PCT No.: PCT/GB2017/052223

§ 371 Date: Jan. 31, 2019

(30) Foreign Application Priority Data
Aug. 1, 2016 (GB) 1613225.0

(51) Int. Cl. G06Q 50/06; G06Q 10/06; G06N 20/10

(52) U.S. Cl. CPC G06Q 50/06; G06N 20/10; G06Q 10/06314

(57) ABSTRACT

A system and method of analysing energy/utility usage receives (316) data describing energy/utility usage derived from an energy/utility monitor, and analyses (2-11) the data describing energy/utility usage to generate data representing an energy/utility usage behavioural classification model. The model includes at least one classification and is useable for determining whether data describing further energy/utility usage fits into a said classification.

The present invention relates to analysing energy/utility usage.

Many countries around the world are currently undertaking a large-scale implementation of smart meters and their associated infrastructures, which offer vast advancements to the traditional utility usage monitoring. A smart meter is an electronic device that records consumption of a utility, such as electrical energy, water, gas or oil, etc, and transfers that information over a communications network, typically in a wireless manner, to a remote body, such as an energy or utility company, for monitoring and billing.

The smart metering infrastructure provides new possibilities for a variety of different applications that where unachievable using the traditional grid topology. Specifically, smart meters enable detailed around the clock monitoring of energy/utility usage. This granular data can capture detailed habits and routines through the users' interactions with systems, devices and appliances. In the case of electricity, each smart meter accurately records the electrical load for a given property at 30-minute intervals and as low as 10 second intervals.

One use of the data provided by smart meters is remote monitoring of people in need of care. In the UK around one in five adults are registered disabled and more than one million of those currently lives alone. Providing a safe and secure living environment places a considerable strain on social and healthcare resources. Effective around the clock monitoring of these conditions is a significant challenge and affects the level of care provided. Consequently, a safe independent living environment is hard to achieve. Current public policy enables sufferers to live independently in their homes for as long as possible. However, it faces significant challenges. For example, current monitoring services are expensive and are met often with patient resistance. The equipment is also intrusive and complex.

Substantial research gaps in non-invasive and cost effective monitoring technology exist, specifically, for safe and effective monitoring solutions that are beneficial to the patient and healthcare providers alike. Any remote monitoring system should facilitate Early Intervention Practice, enabling front line services in the community to intervene much earlier. Much of the current assistive living technologies involve the deployment of various sensors around the home. These include motion sensors, cameras, fall detectors and communication hubs. However, installing, maintaining and monitoring these devices can be costly and complicated and most technologies are considered too intrusive.

Further, existing technical solutions are tailored to a specific application and do not meet the ongoing changing requirements of a patient. Many solutions fail to adequately identify trends in behaviour which may indicate health problems allowing early intervention. Thus, one of the most significant limitations in existing solutions is the absence of personalisation. The inability to learn the unique characteristics and behaviours of each individual and condition degrades the effectiveness of any solution.

Embodiments of the present invention aim to address at least one of the above problems.

Embodiments can utilise smart meter-derived data to provide an innovative remote monitoring system. Embodiments may analyse energy/utility usage by means of machine learning to detect anomalies in a user's electricity usage, for example. In embodiments, energy/utility usage can be collected in a substantially real-time manner. This can establish a person's routine and be used to identify any noteworthy trends in the utilisation of energy-consuming devices and/or utilities. Embodiments can interface directly with a smart meter, enabling them to distinguish reliably between subtle changes in energy/utility usage in real-time.

The data collected can be used to identify any behavioural anomalies in a person's habit or routine, e.g. using a machine learning approach. Embodiments may utilise trained models, which can be deployed as web services using cloud infrastructures or deployed locally to the device to provide a comprehensive monitoring service. The use of machine learning can provide the ability to learn the distinctive features of an individual patient and condition. Embodiments can successfully classify both normal and abnormal behaviours, e.g. using a Bayes Point Machine binary classifier.

With the emergence of cloud infrastructures, the ability to analyse large data and model behaviour in real-time has become feasible. Using cloud infrastructure removes the historical constraints associated with machine learning as these infrastructures offer vast storage and flexible computational resources. Additionally, in order to create an effective monitoring system, the classification models may be accessible to the monitoring applications to provide real-time monitoring. This can be achieved by deploying trained models as accessible services, such as ready-to-use web services. These web services can enable the integration of applications that can be utilised to provide critical information to a patient's support network.

According to one aspect of the present invention there is a method of analysing energy/utility usage, the method comprising or including:

receiving data describing energy/utility usage derived from an energy/utility monitor, and

analysing the data describing energy/utility usage to generate data representing an energy/utility usage behavioural classification model.

The model may include at least one classification. The model may be useable for determining whether data describing further energy/utility usage fits into a said classification. A said classification may specify an energy/utility usage behaviour pattern indicating a typical time of day and/or day of week (and, optionally, duration) when an energy/utility user uses a certain amount or type of energy/utility, e.g. a certain amount of energy/utility (over time) indicating use of a particular energy/utility-consuming device/appliance (or a particular type of device).

The step of analysing the data describing energy/utility usage to generate data representing an energy/utility usage behavioural classification model may comprise:

identifying at least one energy/utility usage signature of at least one energy/utility-consuming device within the data describing energy/utility usage.

The step of identifying at least one energy/utility usage signature may comprise using a machine-learning feature selection technique. A hold out cross validation, for example, technique can be used to find a best said (device) classifier model.

The step of analysing the data describing energy/utility usage to generate data representing an energy/utility usage behavioural classification model may comprise:

analysing the data describing energy/utility usage to identify a behaviour pattern indicating a typical time of day and/or day of week (and, optionally, duration of use) when an energy/utility user uses a certain amount or type of energy/utility, e.g. energy/utility corresponding to use of a said energy/utility-consuming device.

The step of analysing the data describing energy/utility usage to generate data representing an energy/utility usage behavioural classification model may comprise:

analysing the data describing energy/utility usage to identify a behaviour pattern indicating a sequence of usages of certain amounts or types of energy/utility, e.g. a sequence indicating use of a first (type of) said energy/utility-consuming device followed (or preceded) by use of a second (type of) said energy/utility-consuming device.

A said sequence may specify a time of day of usage of a said energy/utility-consuming device; a day of week of usage of a said energy/utility-consuming device, and/or a usage combination/sequence of particular ones of the energy/utility-consuming devices over a specified time period (e.g. hourly, morning, evening, etc).

The step of identifying the behaviour pattern indicating the sequence of usages of certain amounts or types of energy/utility may comprise identifying usage of one or more of the energy/utility-consuming devices during a set of temporal observation windows (e.g. early morning (6:00-8:59 AM); mid-morning (9:00-11:59 AM), . . . , night time (00:00-05:59). The observation windows can be adjusted based on the patient and/or condition while identifying abnormal behaviours/relapse indicators.

The model may comprise at least one device classifier model representing a said energy/utility-consuming device (or type of energy/utility-consuming device) and at least one behaviour classifier model representing a behaviour/usage pattern of a said device by an energy/utility user. The method may comprise identifying a correlation between usage of a said device represented by data describing further energy/utility usage associated with an energy/utility user and expected behaviour in relation to the device by the energy/utility user as represented by the behaviour classifier model. Binary feature vectors of usage patterns of a said device may be predicted using data analytic techniques, such as Machine Learning algorithms, and can be compared with the expected behaviour. The requested device behaviours can be selected based on the type of user behaviour which is to be assessed.

A said device classifier model may be created by using the data describing energy/utility usage as training data for a Machine Learning algorithm. The method may use (only) a portion of the data describing energy/utility usage following an initial detection/start-up period (e.g. around a first 60 seconds of usage) as the training data to identify a particular said energy-utility-consuming device.

There may be a plurality of said classifications, with a first said classification indicating an energy/utility user's normal energy/utility usage pattern and a second said classification indicating the energy/utility user's abnormal energy/utility usage pattern. The method may include performing an action depending upon the classification into which data describing further energy/utility usage fits. If the data describing further energy/utility usage fits into the second said classification (or does not fit into the first said classification) then the action may comprise requesting the energy/utility user to perform a check-in procedure, e.g. sending a message (e.g. indicating that the energy/utility used is OK) to the system, or another user of the system. The action may comprise generating an alert to another user or component of the system, e.g. if the check-in procedure is not performed by the energy/utility user. The method may comprise checking if a check-in request is fulfilled or cancelled and if the check-in request is fulfilled or cancelled then the method may further comprise using the data describing the further energy/utility usage that resulted in the check-in request to update (e.g. by retraining) the behavioural classification model.

The other user/component of the system may comprise an application executing on a computing device, e.g. a mobile telephone or tablet. At least the step of analysing the data describing energy/utility usage to generate data representing an energy/utility usage behavioural classification model may be performed by a web service. The web service may communicate with one or more external computing device/service (e.g. the application) by utilising technologies such as Representational State Transfer (REST) API, LTE etc.

The method may include:

connecting a consumer access device to the energy/utility monitor;

receiving signals from the energy/utility monitor at the consumer access device;

generating the data describing energy/utility usage at the consumer access device based on the received signals, and

transferring the data describing energy/utility usage to a remote computing device for the step of analysing.

The energy/utility monitor may communicate with the consumer access device over a Home Area Network, such as a ZigBee™ wireless network. The energy/utility monitor may comprise a smart meter, e.g. an electricity, gas or water smart meter. Alternatively, the energy/utility monitor may comprise a device configured to generate signals describing energy/utility usage based on output of an energy/utility meter (the output being directly monitored by the energy/utility monitor rather than being received over a communications network).

Some embodiments may receive data describing energy/utility usage received from at least one further energy/utility monitor, and analyse the data describing energy/utility usage received from the at least one further energy/utility monitor to generate the data representing the energy/utility usage behavioural classification model, The energy/utility monitor and the at least one further energy/utility monitor may be of different types. For example, the energy/utility monitor may comprise an electricity meter and at least one further energy/utility monitor may comprise a gas meter and/or water meter.

According to another aspect of the present invention there is provided a method of analysing energy/utility usage, the method comprising or including:

receiving data representing at least one energy/utility usage behavioural classification model;

receiving further energy/utility usage data, and

analysing the received further energy/utility usage data using the model to classify the received energy/utility usage data, e.g. as normal or abnormal.

According to another aspect of the present invention there is provided a system configured to analyse energy/utility usage, the system comprising:

a device configured to interface with an energy/utility monitor and transfer data describing energy/utility usage;

a computing device configured to receive the data describing energy/utility usage and to analyse the data describing energy/utility usage as described herein.

According to another aspect of the present invention there is provided a consumer access device configured substantially as described herein.

According to yet another aspect of the present invention there is provided a remote computing device configured substantially as described herein.

According to a further aspect of the present invention there is provided a communications/energy/utility network comprising components substantially as described herein.

According to yet another aspect of the present invention there is provided a client/server implementation of methods substantially as described herein.

According to yet another aspect of the present invention there is provided an energy/utility meter/monitor configured to execute at least part of a method substantially as described herein.

According to another aspect of the present invention there is provided a computing device including, or in communication with, apparatus substantially as described herein.

According to a further aspect of the present invention there is provided a method of analysing energy/utility usage, the method comprising or including:

connecting a consumer access device to an energy/utility monitor;

receiving signals from the energy/utility monitor at the consumer access device;

generating the data describing energy/utility usage at the consumer access device based on the received signals, and

transferring the data describing energy/utility usage to a remote computing device for energy/utility usage analysis.

According to another aspect of the present invention there is provided computer readable medium (or circuitry) storing a computer program to operate methods substantially as described herein.

According to the present invention, there is provided a method, an apparatus and a system as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

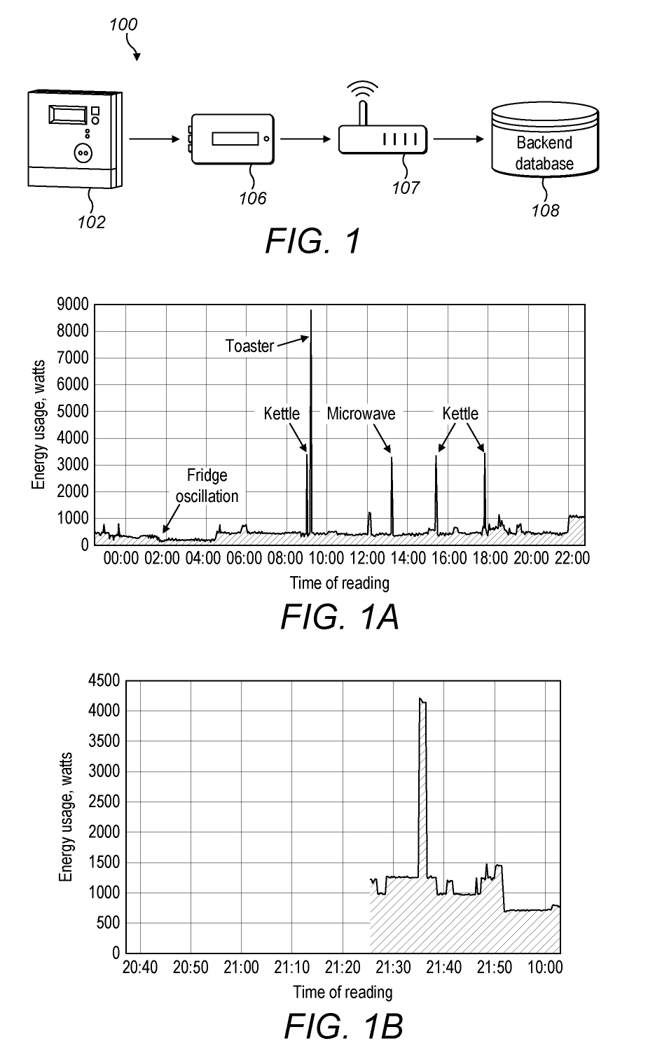

FIG. 1 is a schematic diagram of an embodiment of the energy/utility analysis system;

FIGS. 1A and 1B are graphs illustrating device energy/utility usage over time;

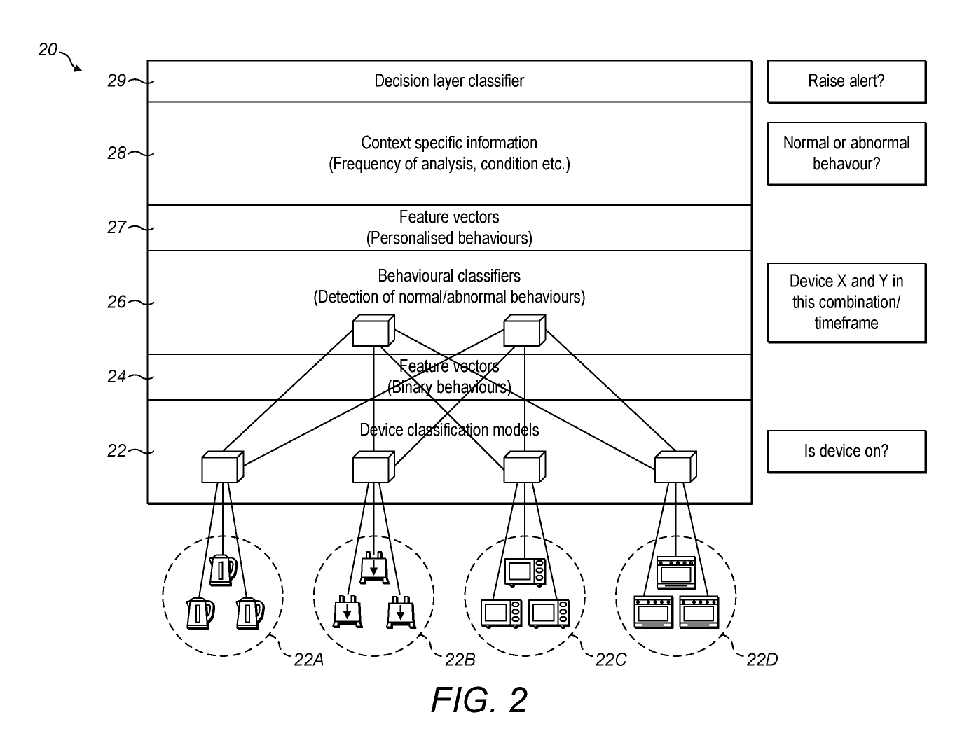

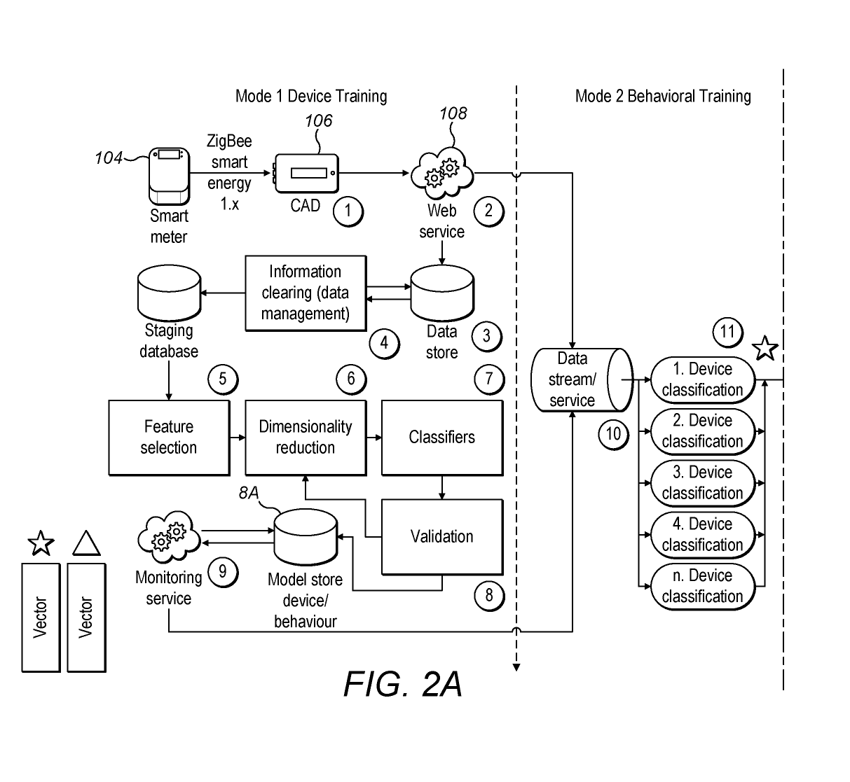

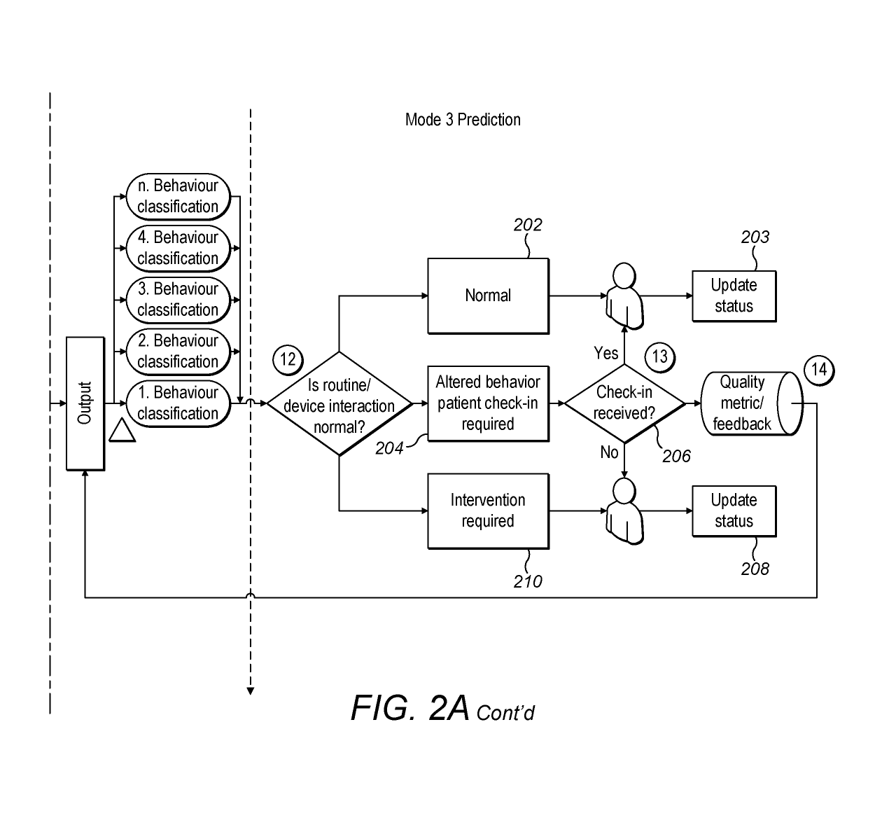

FIG. 2 is a schematic overview of an embodiment of the system;

FIG. 2A schematically illustrates components of an embodiment of the system, as well as steps performed by the various components;

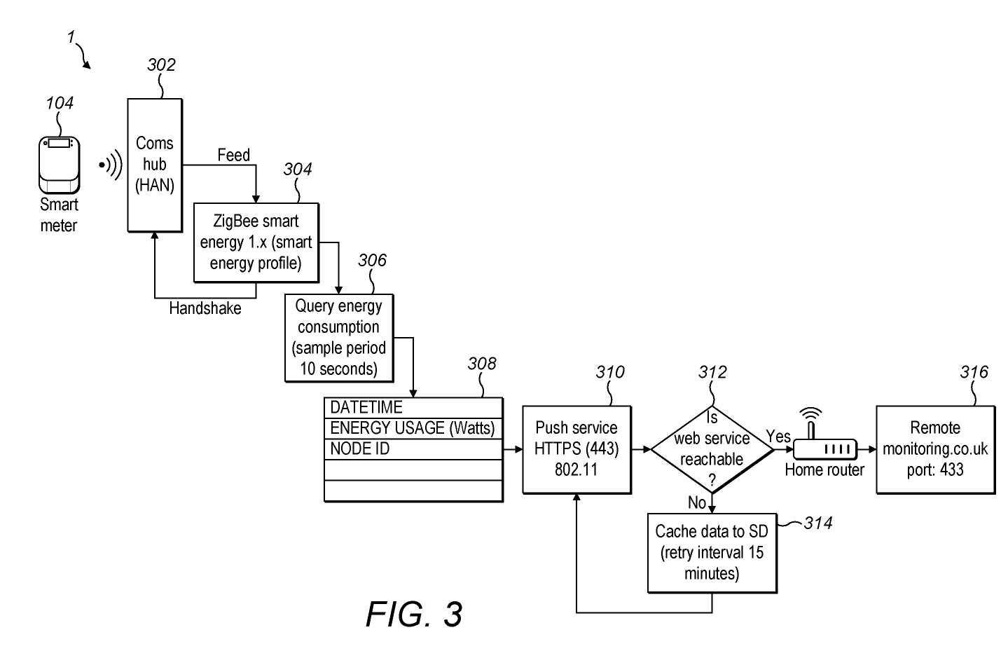

FIGS. 3-10 are flowcharts detailing steps performed by components of FIG. 2A;

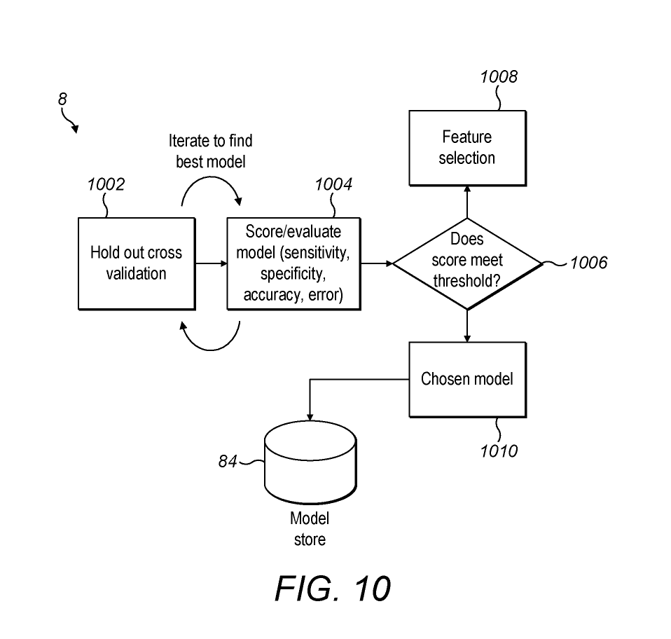

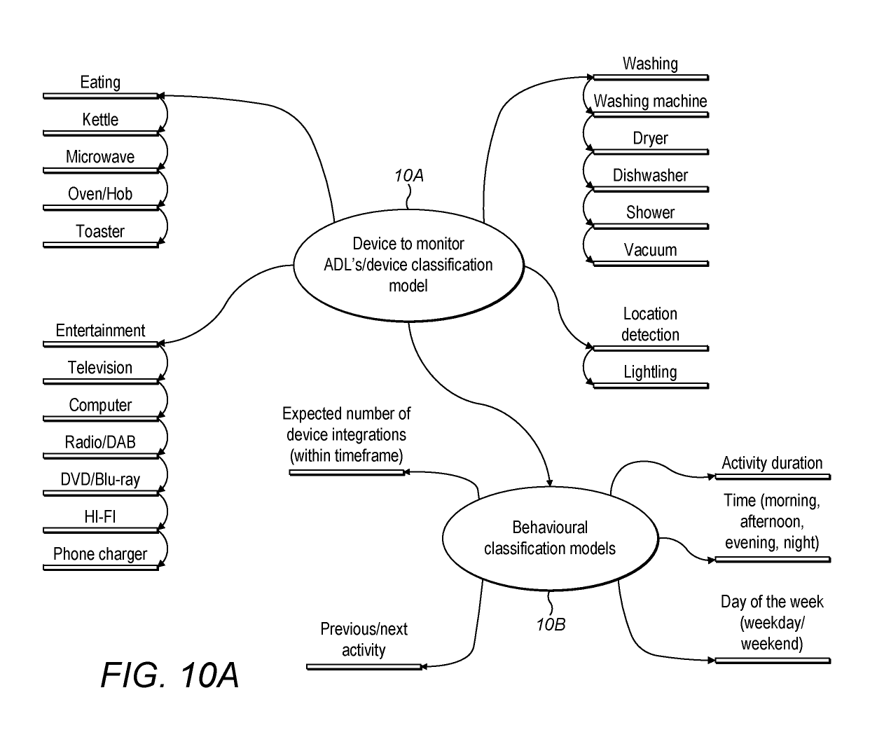

FIG. 10A graphically illustrates device and behaviour models;

FIGS. 11-14 are further flowcharts detailing steps performed by components of FIG. 2A;

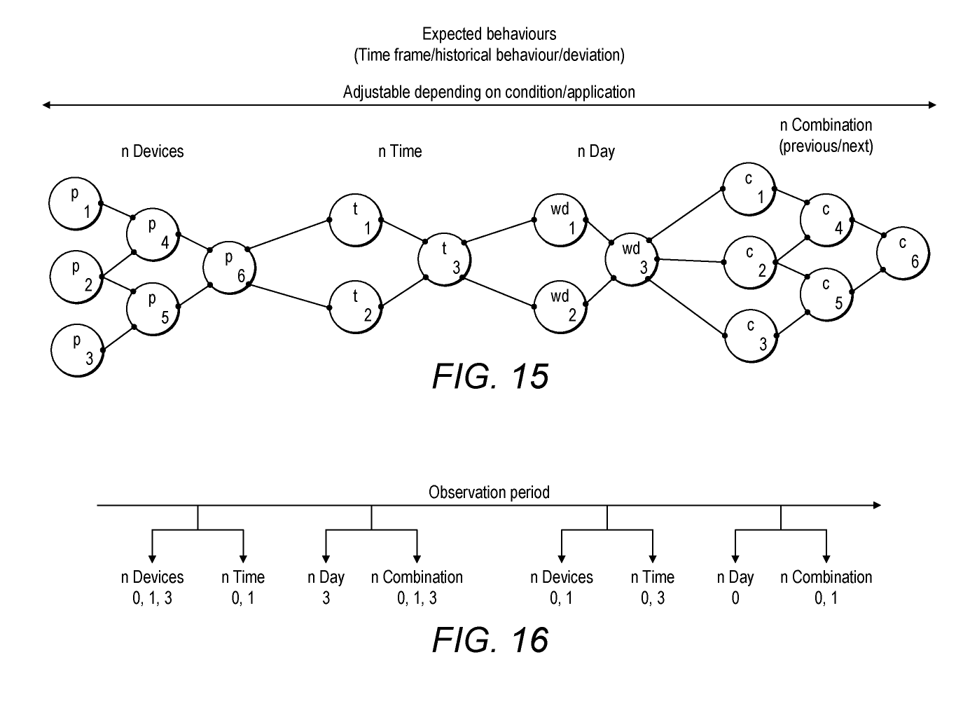

FIG. 15 schematically illustrates parameters that can be processed by a behavioural training mode of an example embodiment;

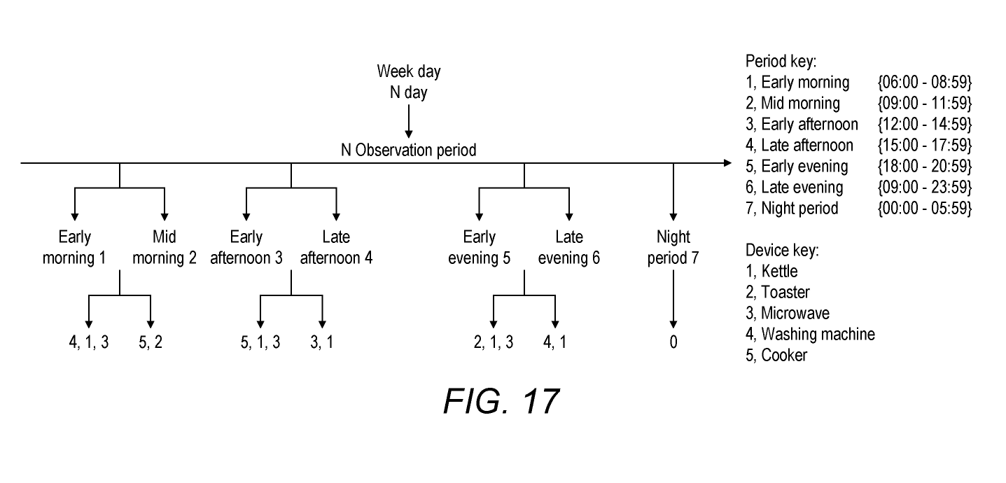

FIGS. 16 and 17 schematically illustrate determining a series of actions undertaken by a patient over time periods by an example embodiment, and

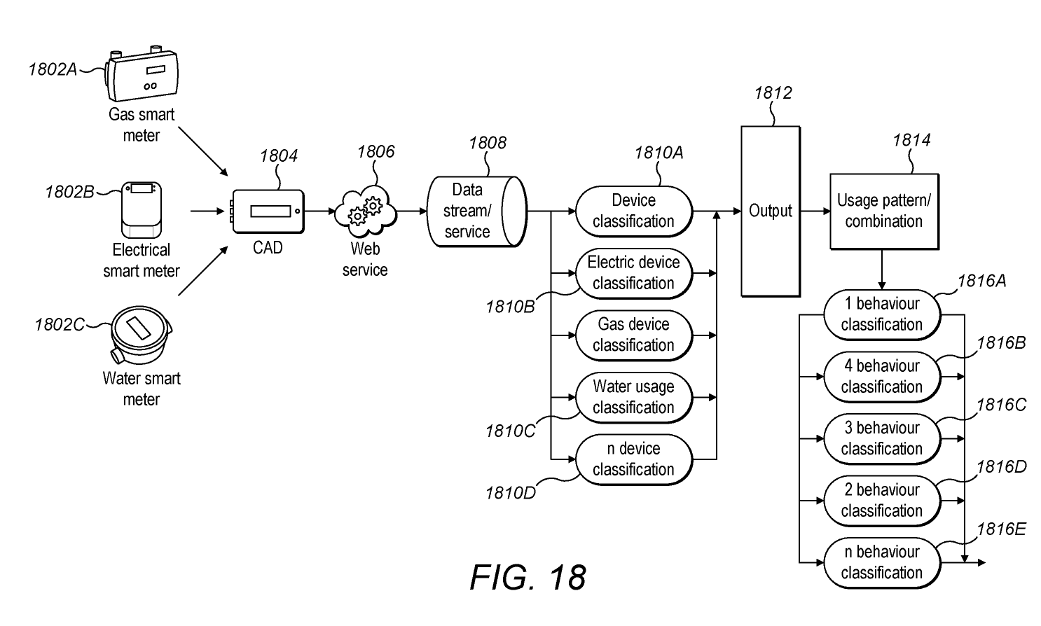

FIG. 18 schematically illustrates components of another embodiment of the system.

FIG. 1 illustrates an example embodiment of an energy/utility usage analysis system 100. In this embodiment a utility meter in the form of an electricity meter 102 is in communication with an energy/utility monitor 106. The energy/utility monitor can include a current sensor transformer clip which, in use, is fastened around a live cable of the meter in order to measure the electrical load. The energy monitor further includes a second sensor, which is an optical pulse sensor, that, in use, senses an LED pulse output from the meter. Each pulse corresponds to a certain amount of energy passing through the meter. By counting these pulses, a kWh value can be calculated by the energy monitor.

The embodiment illustrated in FIG. 1 can be used where an electrical smart meter is not available and the energy monitor 106 is used to simulate smart meter data collection capabilities. In alternative embodiments where the location is fitted with a smart meter then the energy monitor 106, and its physical connection to the meter 102, can be replaced by a smart meter. The skilled person will also appreciate that in alternative embodiments, different arrangements can be used to interface with different types of utility (e.g. gas, water, etc) meters and/or smart meters.

In order to collect energy/utility usage readings from a smart meter a Consumer Access Device (CAD) can be used. A consumer access device can comprise at least a processor, memory and network communication interface, and is able to exchange data with a smart meter and other network equipment, such as a router. Standard smart meters in the UK utilise ZigBee™ smart energy, although it will be appreciated that other communications methods/protocols may be used by embodiments of the system. The UK Department of Energy & Climate Change has announced Smart Metering Equipment Technical Specifications (SMETS) 2, which cites the use of ZigBee™ Smart Energy 1.x. Smart meters establish a wireless Home Area Network in a consumer's home. This is a local ZigBee™ wireless network (the SM HAN), which gas and electricity smart meters and in-home displays use to exchange data. Consumers are also able to pair other devices that operate the ZigBee™ Smart Energy Profile (SEP) to the network. Once a consumer has paired the device to their HAN, a CAD is able to access updated consumption and tariff information directly from their smart meter; a CAD can request updates of electricity information every 10 seconds and gas information every 30 minutes, for instance. The skilled person will understand that other smart meters or energy monitors may produce readings at different intervals.

Increasing the reading frequency, as done by embodiments of the system described herein that use a consumer access device, facilitates the identification of individual device utilisation. For example, obtaining energy readings at around 1 to 10 second intervals can allow construction of individual energy signatures for each device. This can be achieved by identifying the amount of energy being consumed over a period of time (see FIGS. 1A and 1B, for example). This can allow the system to filter out background noise from certain devices, such as refrigerator oscillation, air conditioning and standby electricity usage, in order to identify clear usage signatures for important user devices, such as a kettle, lights and cooking equipment.

The energy/utility monitor 106 (or smart meter) may be configured to transfer the received data, via a router 107 or other suitable network component(s), to a remote computing device 108, which can include a processor, memory, communications interface and other well-known components. The example system can interface directly with a database provided by the remote computing device. The remote computing device will typically not be located at or operated/owned by an energy/utility company and will normally be used primarily for the energy usage analysis methods described herein. It will be appreciated that in some cases the device 106 may process/convert the received data before it is transferred to the remote computing device, e.g. re-format the data, etc. Also, although the embodiment of FIG. 1 is based on wireless communications between the various system components, it will be appreciated that in alternative embodiments, at least one of the communication links can use wired technology.

The energy/utility usage analysis can have various uses, such as controlling the energy/utility supply, or other non-energy supply related uses, such as person/patient health monitoring, building occupancy detection or energy/utility user presence detection for contact, advertising or other purposes (non-exhaustive list). A result of the analysis may be used to perform further actions outside the system components that perform the analysis, such as sending messages between devices, controlling external devices (for instance, power supply to devices in a user's home or elsewhere, e.g. switching on/off lights, alarms, etc). The detailed embodiment described herein relates to patient health monitoring; however, the skilled person will appreciate that alternative embodiments of the system can be produced for other uses/purposes.

In embodiments that are configured to monitor a patient, knowledge of the patient's ability to undertake normal Activities of Daily Living (ADL) is an essential part for the overall assessment. This is imperative in determining the diagnosis and enabling an accurate evaluation of any changes. The following list highlights examples of the main ADL's that can be detected through a patient's interaction with their electrical devices, for example:
Eating patterns—for the purposes of detecting abnormal or altering changes in eating habits. These types of behavioural changes provide key indicators regarding the general health of the patient.
Sleep patterns—changes in sleep patterns can provide insights into a patient's mental and physical wellbeing. Sleep disturbances are often key indicators for various mental health problems.
Behavioural changes—provide impotent indicators for the detection of new conditions while providing information about the progression of existing medical problems.
Changes in activity—can highlight possible periods of inactivity. These types of changes would require intervention to prevent additional complications and worsening of a patient's condition.
Routine alteration—is vital for detecting changes in a patient behaviour and forms a key part in our system for the purposes of facilitating independent living. The identification of a route change especially in more serious conditions such as dementia can indicate the need for immediate intervention.
Analyse what effects social interactions have on consumers and if the benefits are short or long lasting. This is important for assessing the mental wellbeing of a patient.

Being able to detect subtle changes early and predict future cognitive and non-cognitive changes facilitate much earlier intervention. Often, dementia sufferers in hospital are admitted due to poor health caused by other illnesses. These illnesses are often a result of immobility in the patient, most commonly infections cause additional complications and can also speed up the progression of dementia. Additionally, immobility leads to pressure sores, which can easily become infected, other serious infections and blood clots, which can be fatal. With any of these complications early intervention for both preventative care and early treatment is vital to ensure a good prognosis and safe independent living.

FIG. 2 is an overview of an example of a system 20 adapted to monitor patients based on electrical energy usage. The example system typically firstly receives a set of data energy describing energy usage that can be used to train the system's classifiers. The data will preferably be based on a sample of several energy users. For one example system, one year's worth of energy usage readings for 8 different smart meter users was selected. The 8 consumers were selected as a sub group of the population as they accurately represent the population as a whole, this approach was practical for initial data analysis. Out of the 8 consumers selected 4 have normal readings and 4 have abnormal readings. The subjects with normal readings were classified as having no energy usage readings greater than 2 Kwh between the hours of 1:30 and 4:00 for the entire year period. Abnormal subjects were classified where they exceeded 2 Kwh between the hours of 1:30 and 4:00 on 3 or more occasions in a one-year period. All households in the experiment have one occupant to ensure accurate results. Initially 7 features per consumer were derived for each 24-hour period totalling 8760 results for each of the following features: General supply min; general supply max; general supply median; general supply standard deviation; general supply mean; off peak max and off peak mean.

In typical embodiments the data processing components of the system 20 can operate in three modes: firstly, a device training mode, which involves collecting and processing energy/utility usage data in order to generate classifiers that identify which device(s), e.g. electrical devices such as a kettle, toaster, etc, is/are being used by a user. Secondly, a behavioural training mode that generates classifiers that identify behaviours of the user based on the energy/utility usage information. Thirdly, a prediction mode that identifies both normal and abnormal behaviours using the trained classifiers from the training mode. When the system is in the training mode, normal and abnormal data is collected from the data store. Normal data refers, for example, to a patient's usual behavioural routines in a household. Abnormal data relates to a deviation from expected patterns of behaviour.

In order to perform the classification of the data, a selection of classifiers were used in embodiments. Examples of these include: back-propagation trained feed-forward neural network classifier (BPXNC), Levenberg-Marquardt trained feed-forward neural net classifier (LMNC), automatic neural network classifier (NEURC), radial basis function neural network classifier (RBNC), trainable linear perceptron classifier (PERLC), voted perception classifier (VPC) and the random neural network classifier (RNNC). These also employ a supervised learning approach, which can be a key part of the approach. The inventors found NEURC to be most accurate in some example cases. The skilled person will appreciate that embodiments of the system can utilise various machine learning, artificial intelligence, neural network and other classification techniques. In addition, or alternatively, non-machine learning techniques involving linear and logic regression, for example, can be employed.

The present inventors found that using the above techniques supported findings that neural networks can be used to detect abnormal behaviour in smart meter datasets for health care monitoring. Using this approach, embodiments of the system are able to perform an analysis of real-time datasets to detect when a user's behaviour is changing as a result of illness. The NEURC classifier in particular can provide an accurate monitoring algorithm for monitoring people living with self-limiting conditions requiring an enable early intervention practice.

Data features are extracted from the data set in order to train the classifiers to be able to detect abnormal patterns in a dataset. When the system is in training mode, data is collected from the data store in order to extract features, which are needed for training the classifiers. The features relate to behavioural patterns of the individual. While in the training mode, the information clearing component can run a set of queries against the data store for a specific patient condition or application. Each query may return a balanced data set for both normal and abnormal behaviours. A balanced dataset is required for the classification process as it removes the possibility of a bias prediction and misleading accuracies. The period and type of energy usage data collected varies. Each training iteration is application specific.

Thus, based on the training data (and, typically, further data describing energy/utility usage upon which monitoring is also performed), the system 20 generates a set of device classification models 22. Models must correctly identify devices, including when they are being used in combinations. This is achieved by training the models, using only the minimum number of observations possible. By identifying the appliance in the shortest possible timeframe, devices can be classified by using their unique start up modes. By reducing the number of observations (specifically to the first 60 seconds of usage) it enables the classifier to identify both type 1 (on/off) and type 2 multi-state devices (MSD). As MSDs consume similar amounts of energy during start-up they are identified before variations in the energy usage signal begin.

In the health monitoring embodiment based on electrical energy analysis, each classification may represent a class of domestic devices, such as kettles 22A, toasters 22B, microwave ovens 22C, ovens 22D, etc. However, in alternative embodiments the devices may be any domestic, commercial or industrial systems/components/appliances/devices, including computers, light systems, water/plumbing systems or components (e.g. sink, bath, washing machine), gas-consuming devices/systems (e.g. oven, hob, heater), etc. In a prediction mode the device classifiers can detect whether a particular type/class of device is being used based on analysis of the data describing energy usage. The output of the device classifiers can comprise feature vectors 24, which may be a binary representation of whether a particular class of device is on/off.

The output can be used by behavioural classifiers 26. In embodiments, these classifiers can generate an indication of whether the device on/off usage within data describing energy usage is normal or abnormal, for example (although it will be appreciated that for non-health monitoring embodiments, the classifications may vary, e.g. building empty/occupied; no one/one person present/more than one person present, etc). The normal/abnormal classification may be based on analysis results such as the time or day and/or day of week a particular device/class of device/utility is being used; a combination/sequence of usage of devices/utilities, or any other appropriate behavioural analysis, e.g. behaviours that indicate that a person is not eating regularly, visiting the bathroom very frequently, etc.

In some health monitoring embodiments the system 20 may further produce feature vectors 27 that may be used to refine behavioural analysis based on factors associated with an individual patient. For example, if a particular patient's condition is expected to deteriorate over time then this can result in certain analysis/classifications being performed more or less frequently. Some embodiments may also take into account context specification information 28, which may also result in certain analysis/classifications being performed more or less frequently. Embodiments can also comprise decision layer classifiers 29, which in the case of health monitoring systems, can decide whether to raise an alert based on the results of earlier classifications.

FIG. 2A schematically illustrates components of an embodiment of the energy/utility usage analysis system 200, as well as steps performed by the various components. In the embodiment of FIG. 2A a smart meter 106 performs operations labelled 1 to transmit signals/data describing energy usage to a consumer access device 106, which relays data corresponding to (or based on) the received data to a remote computing device 108. The remote computing device executes an application that performs energy usage analysis. In some embodiments, the remote computing device can provide a web-based service that performs operations labelled 2. In some embodiments, an application may also be provided to the patient (the user of the energy being analysed) and/or a carer. Such applications can be for use on a computing device, such as a smart phone or tablet, that can exchange data with the remote computing device. Each patient and carer will normally have to register their details as users of the system/application.

It will be appreciated that the illustrated embodiment is exemplary only and that some of the functions may be performed by either the device 106 or the remote computing device 108, or may even be integrated into a version of a smart meter/energy monitor, network router device, etc. It will also be appreciated that the computing devices and data stores used by embodiments may be distributed across several devices/locations and/or provided by cloud services or the like. The skilled person will further understand that the processes described herein can be implemented using any suitable programming language and data structures. Also, the sequence of steps illustrated in the flowcharts is exemplary only, and some may be re-ordered or omitted. Further, additional steps (not illustrated) may also be performed in alternative embodiments.

The data received from the device 106 can be logged remotely to, for example, a cloud SQL database and used to create, test and deploy the classification models. Once the model is generated the classification models need to be accessible to the end user applications to provide real-time monitoring. This can be achieved by deploying trained models as the ready-to-use web services. Once the web service is deployed, data from the SQL database can be directly sent to the service for active monitoring. The generated monitoring applications can interface with a service API key to receive real-time monitoring alerts about a patient's wellbeing.

The remote computing device 108 includes, or is communicating with, a data store 3 that stores the data received from the device 106 (and/or data based on the received data). The remote computing device performs information clearing/data management operations 4 on the data in the store. The resulting data is stored in a staging database and is used by a feature selection process 5. The remote computing device can then perform a dimensionality reduction process 6 and classifiers operations 7. A validation process 8 can then be performed. A model store 8A device/behaviour data is provided for use by a monitoring service 9. The device training mode typically involves the items labelled 1-9 in FIG. 2A.

Data from both the web service 2 and the monitoring service 9 are made available as 20 a data stream 10 that is processed by a device classification process 11. The output of this is processed by a behaviour classification process. The behavioural training mode typically involves the items labelled 10-11.

The result of the behaviour classification step is used to determine a next action to be taken by the system at operation 12. In the example prediction mode the system uses the trained classifiers to automatically detect both normal and abnormal patient behaviour substantially in real-time. Where appropriate, the system alerts the patient's support network to a potential problem if detected. If the route/device interaction is classified as normal 202 then the application may be updated to indicate normal status 203 (with no patient/user action is required). In the first instance of detecting abnormal behaviour 204 the system alerts the patient to check in 206 (operation 13), by performing specific device interaction. This reduces the risk of any possible false alarms and verifies that the patient requires no further assistance. However, this function largely depends on the type of condition being monitored and may be deactivated where it is believed unsafe or where a patient is deemed unable to interact. The system identifies 15 if interaction has taken place; if this is not the case then an alert 208 may be communicated to a third-party health care practitioner or family member, for example. In order for embodiments to alert the registered user, a monitoring app can communicate with the web service by utilising a Representational State Transfer (REST) API. A REST API facilitates the integration of multiple programming languages and platforms. Each app can operate the same API to obtain, update and manipulate data, which ensures compatibility with existing services. By making use of a compatible API, embodiments can be integrated with existing services, e.g. via UK National Health Services Digital Services: General Practitioner services (EMIS Web Vision Evolution); Hospitals/Walk-in Centres (Simga); Telehealth (EMIS Web Vision); Clinical Decision Support (Infermed), etc.

If a further instance of abnormal behaviour is detected 210 then an alert 208 may be raised immediately. Quality metrics/feedback (operation 14) may be performed, e.g. based on an administrator or care-giver's feedback, where a score may be allocated to a particular outcome with a view to improving future predictions. This can ensure that embodiments are adaptable and self-learning.

Some embodiments also support a sleep function, which deactivates the process and can be enabled from the monitoring application. This can be used if the patient is away from the premise for long durations, such as being on holiday, and reduces the likelihood of false alerts.

FIG. 3 schematically illustrates examples of the operations labelled 1 in FIG. 2A that are performed by the smart meter 106 in conjunction with the consumer access device 106. At steps 302-304 the smart meter performs handshake operations with the consumer device. At step 306 an energy consumption query is performed at specific intervals (e.g. around 1-10 seconds), which can result in data describing energy usage 308 being provided to the consumer access device by the smart meter. In an example embodiment the data describing energy usage can comprise the date/time of the reading; a measure of the energy usage (e.g. watts, based on a meter reading) and an identifier of the smart meter/customer. However, it will be appreciated that the data describing energy usage can take other forms and/or include more or fewer data items, e.g. it can contain another indication of time (e.g. minutes lapsed since a start time) instead of a time/date stamp; it may contain a measurement other than watts (e.g. joule/second), etc. At steps 310-314, the consumer access device 106 performs steps to communicate the data describing energy usage to a router device, which, at step 316, relays the data (or data based on it) to the remote computing device 108 that provides the web service, e.g. via a secure internet protocol.

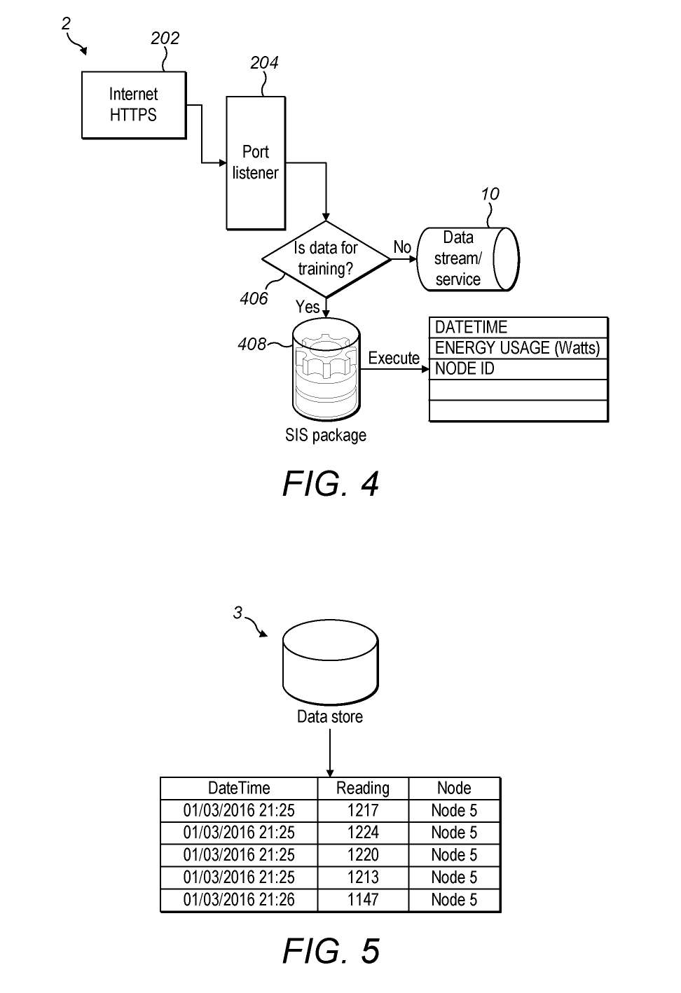

FIG. 4 schematically illustrates examples of the operations 2 that can be performed by the remote computing device 108 providing the web service. At steps 402-404 the data describing the data usage is received, e.g. at a port listener of the remote computing device via HTTPs protocol. At step 406 the remote computing device checks whether the received data is intended for training (e.g. based on a setting by a user of an energy usage analysis application running on the remote computing device). If it is not then the data is treated as a data stream (the operations labelled 10), but if it is then stored for training processing, e.g. as a Server Integration Service package 408 in embodiments of the system that use an SQL database.

FIG. 5 illustrates an example of the data describing energy usage in the data store 3, where each entry comprises a time/date field, an energy amount reading field and a node/user identifier field.

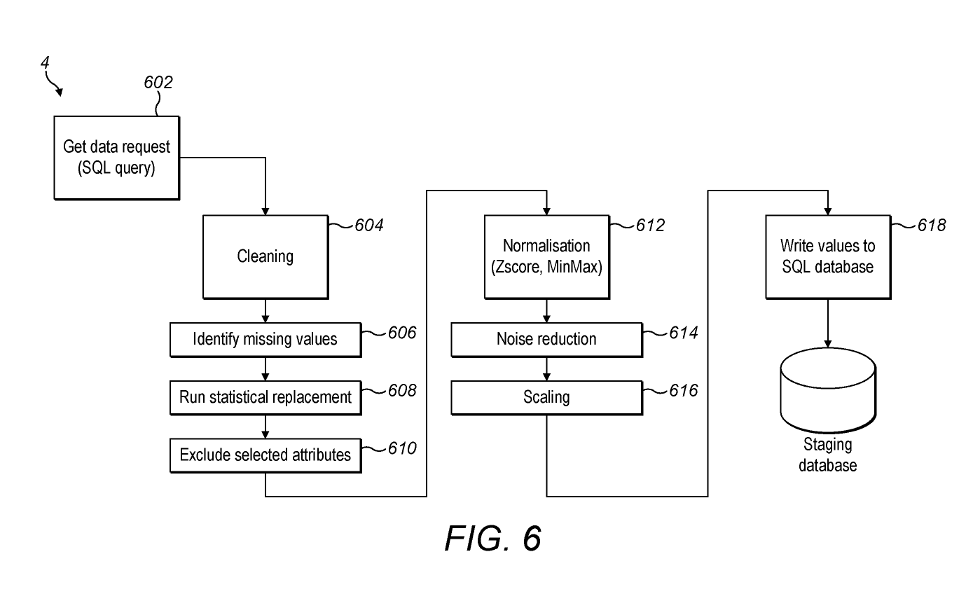

FIG. 6 schematically illustrates examples of the operations 4 that can be performed by the remote computing device 108 during the information clearing/data management process 4. At step 602 a data request is received, e.g. an SQL query. Here, the system starts the data preparation process. At step 602 the data is retrieved from the data store using a query, for example SQL. In order to achieve the best classification results the selected training data needs to be cleaned, as shown in steps 604-616. This process removes any missing or null values, as most algorithms are unable to account for missing data. An example known technique for this process is statistical replacement. In step 606, missing values are identified. At step 608 different values, such as median or mode, can be used to replace missing values. In addition, a known technique such as the multiple imputation method can be deployed to fill in any missing values in data. The data cleaning process also provides an opportunity to exclude particular attributes, as shown in step 610. In steps 612 to 616 the data is normalised to maintain the general distribution and ratios, ensuring that it confirms to a common scale. Examples of suitable methods include: Zscore, MinMax and Logistic. Once these steps are complete the data is written to a staging database at step 618.

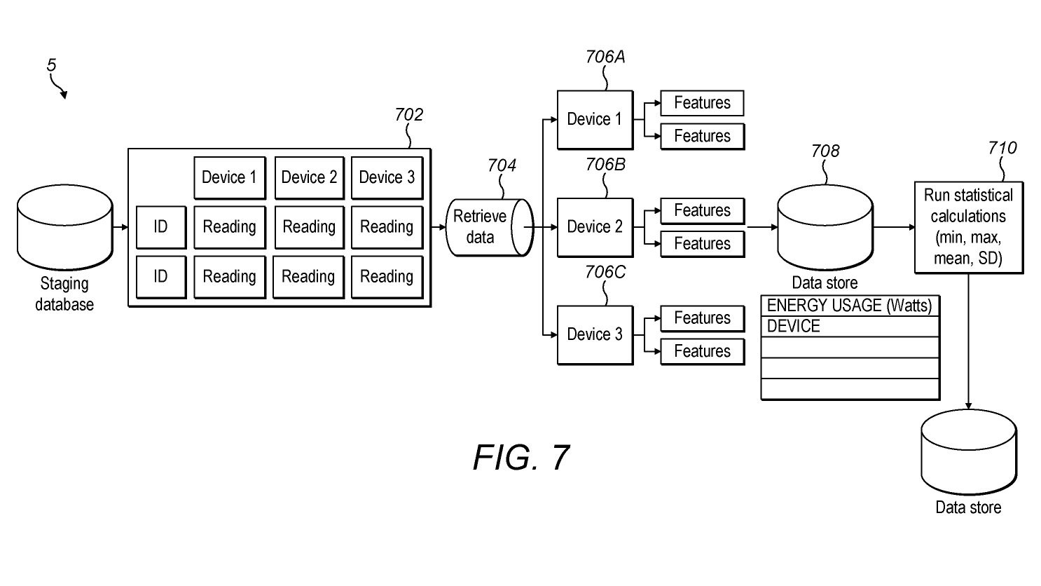

FIG. 7 schematically illustrates examples of the operations 5 that can be performed by the remote computing device 108 during the feature selection process. Once the data cleaning is complete the processed data is retrieved from the staging database. At step 702 each reading sample is assigned an ID and labelled ready for classification. During steps 704-706A-706C the features for each device are extracted and placed into the data store in step 708. This process utilises unique features that support device signature identification. These include energy power and consumption levels, for example. In step 710 the system extracts more complex features from the data. Example features include: time frequency, non-linear and heuristic minimum-Redundancy-Maximum-Relevance (mRMR).

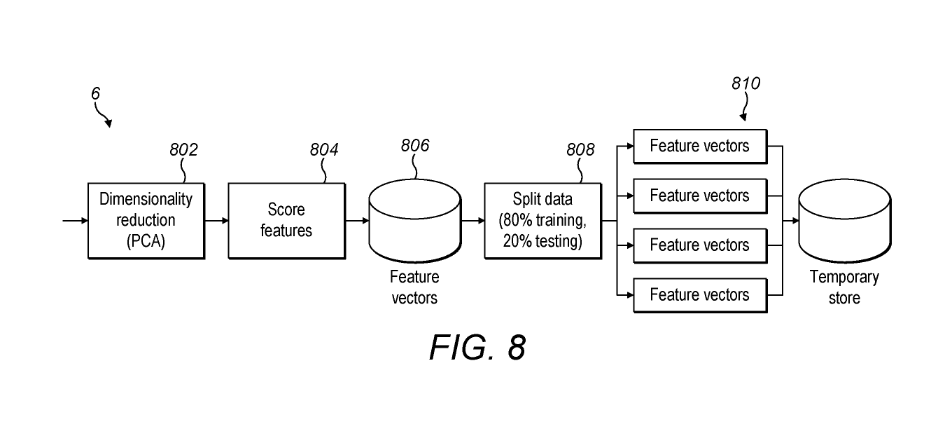

FIG. 8 schematically illustrates examples of the operations 6 that can be performed by the remote computing device 108 during the dimensionality reduction process. In order to ascertain the optimum features and the greatest variance for the classification, Principle Component Analysis (PCA) may be undertaken on the features created from the variables in the dataset (with each variable being a smart meter) during the feature selection step. In one embodiment, general supply min, general supply max, general supply median, general supply standard deviation, general supply mean, off peak max and off peak mean, were devised from each variable to establish a total set of 28 features. However, other features as previously described could be used to establish a larger feature set. Using this methodology helps to ensure the identification of the most useful features and a reduction in the number of features was obtained (in one example, a reduction of 67%, with 9 left out of the original 28).

At steps 802-810 the system deploys a dimensionality reduction technique to improve the overall classification result. Examples of suitable techniques include: Principle Component

Analysis (PCA) and Karhunen-Loeve Expansion. Once step 802 is completed, the individual features are scored in step 804. The first principle component has the largest possible variance with each sequential component reducing in terms of its variance, until they become unsuitable for classification. Example of suitable methods for scoring and selecting the features include: Cattell's Scree test and the Brocken Stick Method. In step 806 the reduced number of features are placed in a database. In order to successfully train and score the classifiers the data is divided in step 808. The hold out cross validation technique is deployed using, e.g., 80% of the data for training while the remaining 20% was used for testing. Other techniques such as K-fold Cross Validation can also/alternatively be deployed at this step. In step 810 the data is then stored in a temporary database ready for classification.

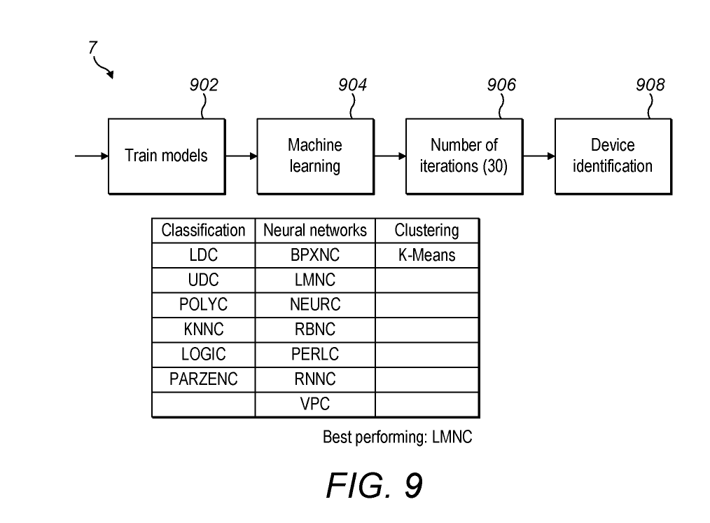

FIG. 9 schematically illustrates examples of the operations 7 that can be performed by the remote computing device 108 to generate the classifiers. At steps 902-908 the individual classifiers, examples of which are listed below step 904, are trained. Each classifier experiment is run against the training data set, each is assessed multiple times against randomly sampled training and testing sets for each iteration, e.g. 30 iterations. Each of the classifiers' predications is noted for the validation process.

FIG. 10 schematically illustrates examples of the operations 8 that can be performed by the remote computing device 108 during the validation process. Here, hold out cross validation, for example, can be used to find the best model, which is then stored in the device/behaviour model store. At steps 1002-1010 the withhold data is introduced. This withhold data scores the performance of the model and to evaluates how effectively the model can predict future or unknown values. In Step 1004 each model is scored and evaluated through mathematical techniques which may include calculating the sensitivity, specificity and accuracy or Correct Classification Rate (CCR). This can be expressed mathematically as shown below:

Sensitivity=Tₙ/(Tₚ+Fₙ) (1)

Specificity=Tₙ/(Fₚ+Tₙ) (2)

CCR=(Tₚ+Tₙ)/n (3)

The process is iterated to find the best model for each electrical device. In step 1006 the system determines whether the overall accuracy of the model is acceptable for the application. If the minimum threshold is not met the system selects new features to improve the classification result. If the score exceeds the minimum threshold the model is stored in the model store as shown in 1010 ready for use in real-time production.

FIG. 10A schematically illustrates device types of an example device model 10A and also features of an example behaviour model 10B.

FIG. 11 schematically illustrates examples of the operations 9 that can be performed by the remote computing device 108 to provide the web monitoring process. Here, a user's device 106 can provide data describing energy usage in a secure manner for use in the device training. Steps 1102-1108C enable stage 1 of the real-time monitoring process. This system process is server-side. The operation sets up the model of device behaviour to be sent to data streaming operation 10. Specifically, a created API communicates with web store and sets up input out for actual service. The process takes in the behaviour models of devices and uses protocols to contact the monitoring services. A unique access key in 1108B ensures the process is secure. The web service URL enables access to the real-time data for assessment in 1108A and in 1108C sends the output data to data streaming operation 10.

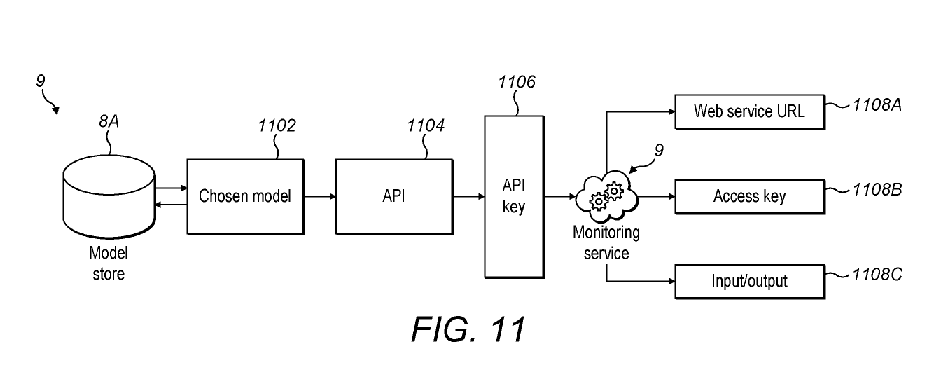

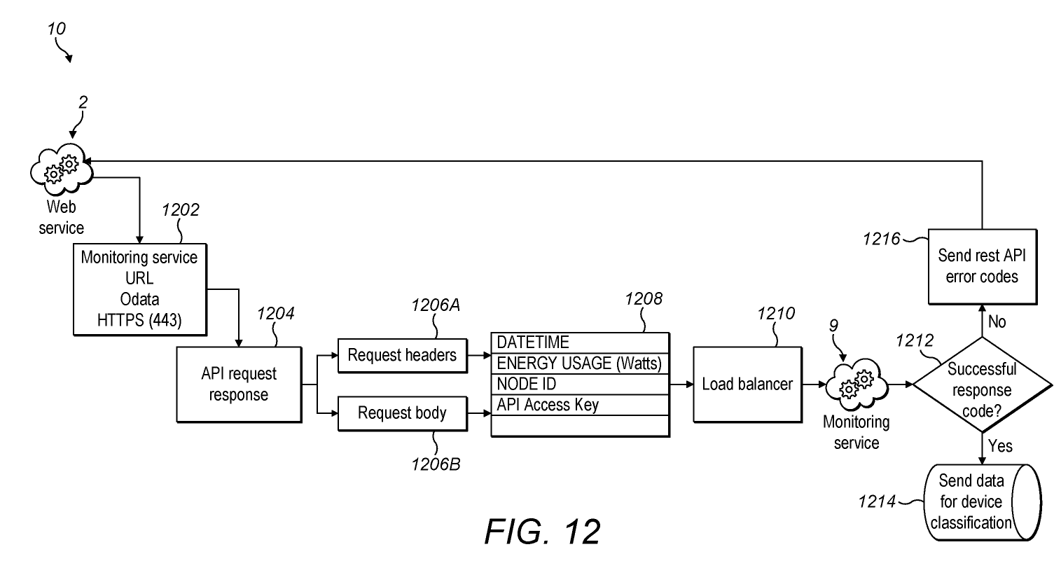

FIG. 12 schematically illustrates examples of the operations 10 that can be performed to provide the data stream service. Here, data describing energy usage is received from the user's device 106 in a secure and efficient manner for use in the device classification operations 11. At steps 1202-1214 this process 10 communicates with operation 9 to enable stage 2 of the real-time monitoring. The process sits next to the CAD. It searches for the URL at 1202, provided by operation 9 at step 1108A, and receives the API response at steps 1204, 1206A, 1206B. Step 1208 depicts examples of expected data received at this stage. The load balancer at 1210 ensures the system data is not overloaded and data is requested in windows/packet sizes which are manageable. Step 1212 checks for the correct API code and feeds back any errors via 1216. Step 1214 forwards the data to the operation 11.

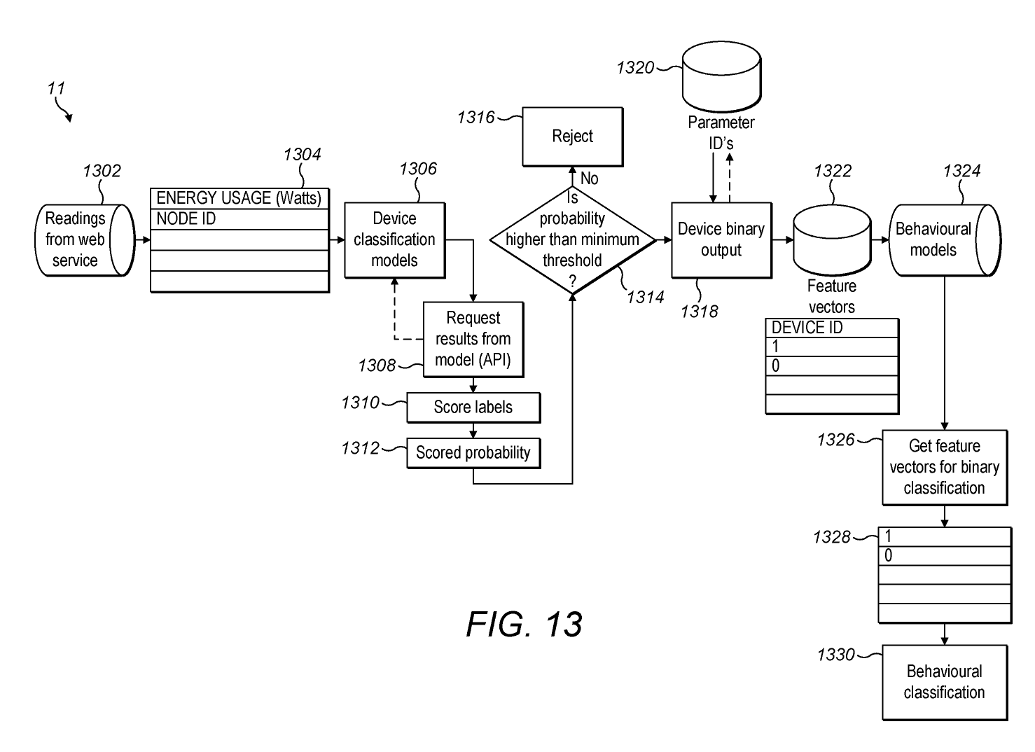

FIG. 13 schematically illustrates examples of the operations 11 that can be performed by the remote computing device 108 to provide the device classification process. At steps 1302-1330 a correlation between individual electrical device/appliance behaviours within the energy user's home and an individual's personalised behaviour is formed. Live readings are taken from devices within the home. Binary feature vectors of individual electrical device patterns, predicted using advanced data analytic techniques, such as Machine Learning (for example: Bayes Point Machine binary classifier, Uncorrelated Normal Density based Classifier (UDC), Quadratic Discriminant Classifier (QDC), Linear Discriminant Classifier (LDC), Polynomial Classifier (PLOYC), k-Nearest Neighbour (KNNC), Decision Tree (TREEC), Parzen Classifier (PARZENC), Support Vector Classifier (SVC) and Naïve Bayes Classifier (NAIVEBC)) or Neural Network algorithms (for example: back-propagation trained feed-forward neural network classifier (BPXNC), levenberg-marquardt trained feed-forward neural net classifier (LMNC), automatic neural network classifier (NEURC), radial basis function neural network classifier (RBNC), trainable linear perceptron classifier (PERLC), voted perception classifier (VPC) and the random neural network classifier (RNNC)), are compared with expected patterns of behaviours for the user within the home. Specifically, data is input via step 1302 and a temporary data store is built up at step 1304 containing the readings from the profiling in Mode 1 in FIG. 2A. At step 1308 specific device behaviours are requested from steps 1304 through 1306. The requested device behaviours are selected based on the type of user behaviour which is to be assessed. The models of behaviour are scored in steps 1310 and 1312. The model is checked in 1314, and if not suitable is rejected in step 1316. Individual behaviours are stored as feature vectors in binary output in step 1318. Where device ID's are stored in step 1320 and the device feature vectors stored in step 1322. Steps 1324 to 1330 perform correlation between expected user behaviour types and device behaviour patterns.

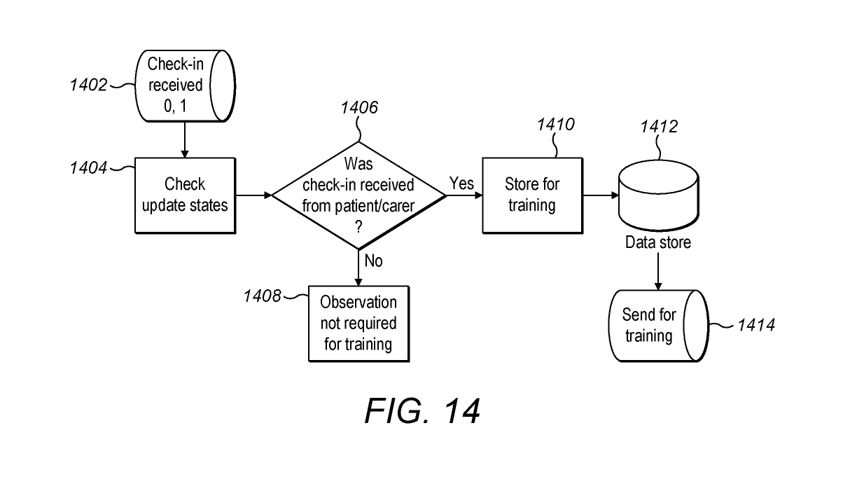

FIG. 14 schematically illustrates schematically illustrates examples of the operations 14 that can be performed to provide a feedback mechanism. Embodiments can recognise if a previously identified behaviour has been incorrectly predicted by checking the update status. If an alert is cancelled then the behaviour is reassessed and feedback is provided into the behavioural models, which are used to retrain the system. At step 1402 a notification is received. Each notification is assigned a binary value which identifies if the generated alert is valid. If an intervention is required and no check in was received, then embodiments may assign a binary value of 0 to the observed behaviour. However, if a patient check-in is received or if the carer cancels the alert (suggesting that the status indicating the need to request the check-in was incorrect) then the observation is assigned a binary value of 1. At step 1404 embodiments can check the update status and at step 1406 examine each generated status to ascertain if the alert was valid. If the query returns a value of 0 then at step 1408 the embodiment may discount the alert because the status is valid. However, if a value of 1 is returned then at step 1410 the behavioural observation is retained in data store 1412, which can be sent (step 1414) for future retraining.

FIG. 15 schematically illustrates parameters that can be processed by an example embodiment of the behavioural training mode. During this mode, the patient's behaviour is assessed, which enables the system to make a decision regarding the patient's welfare. During this process, a decision is made based on aspects of the patient's routine. FIG. 15 highlights examples of the parameters that are presented to the behavioural models for behavioural analysis. Firstly, p represents the specific devices being used. A unique value can be assigned to the identified device. Next, t represents the time of utilisation, which is required for identifying unusual behaviour or deviation from routine. wd records the day of the week, enabling the algorithm to construct detailed knowledge concerning the unique routines of the patient. c denotes the combination of devices over specified time periods e.g. hourly, morning, evening etc. Identifying normal device combinations provides insight to both the mental and cognitive functions of the patient.

The table below highlights the different features that can be assessed by the behavioural models. The types of devices and behavioural characteristics, which are considered key for patient assessment, are also shown:

| Feature | Description |
|---|---|
| Device Usage | Type of Device {Kettle, Microwave, |
| (Activity) | Oven/Hob, Toaster, Washing Machine, Dryer, |
| | Dishwasher, Shower, Vacuum, Television, |
| | Computer, Radio/DAB, DVD/Blu-ray, HI-FI, |
| | Phone Charger, Lightings} |
| Time | Time of Activity {Time of Device Integrations} |
| Day | Day of the Week {M, T, W, TH, F, SA, SU} |
| Device Combinations | Devices used in combination with each other |
| | (e.g. kettle and toaster used at same time to |
| | make a breakfast meal; shower shortly |
| | followed by hair dryer, etc). |

Some embodiments can categorise routines by determining the specific series of actions undertaken by the patient over a specified time period. This process is illustrated in FIG. 16. Routines can be stored in behavioural logs, which are converted into sequences of events.

This approach can cater for patient personalisation. The behavioural classifiers can take into account the unique characteristics of the patient and their particular routines. For example, FIG. 17 highlights seven distinct observation windows for a 24 hour period. Here the individual values for each period and device class are displayed, which are used to generate the features for the behavioural classification models. Some embodiments can monitor a set of specific observation windows to ascertain the behavioural structure of the patient. These windows can be used singularly or in combination up to maximum of 24 hours depending on the application or condition. The observation window can be adjusted based on the patient and condition while identifying abnormal behaviours.

During the prediction mode, some embodiments may formulate a decision regarding the patient's wellbeing. This can be achieved by analysing both the device usage and behavioural features form the first two modes of operation. For example, in operation 12 of FIG. 2A, a binary classifier can establish the patient's behaviour. By exploiting the trained classifiers and the generated model, embodiments automatically detect both normal and abnormal patient behaviour in real time using web services. Where appropriate, the system may alert the patient's support network to a potential problem, if one is detected.

FIG. 18 schematically illustrates an embodiment that can monitor the use of additional utilities, including gas and water. It will be understood that the detection and analysis of one or more additional/alternative type(s) of utility that can be used to assess ADLs is possible. Cooking equipment such as gas ovens and hobs can be identified in a similar manner to electrical devices as described above. Likewise, the identification of water consumption can be used to detect bathing habits such as using a bath or shower. Combining observations from multiple utilities can facilitie the construction of a more detailed behavioural pattern, which can be used in combination to detect concerning behaviour. The monitored use of electricity, gas and water, etc, can be combined to assess usage patterns and combinations in a similar manner to that described above in relation to electrical energy usage.

In the embodiment of FIG. 18 a plurality of smart meters (gas 1802A, electricity 1802B and water 1802C in the example) transmit signals/data describing utility usage to a consumer access device 1804, which relays data corresponding to (or based on) the received data to a web service 1806 that performs utility usage analysis. The web service can transmit data via a data stream/service 1808 to classification models 1810A-1810D. Each of these models may relate to a device that consumes electricity and/or gas. One of the models 1810C classifies water usage. Once the models have been generated they can be output 1812 for real-time monitoring/training. Data from the web service and/or at least one other source, such as a monitoring service, can be used for a usage pattern/combination behaviour classification process 1814, which can output a set of behaviour classifications 1816A-1816E. Analysis of behaviour based on these classifications can be used to determine a next action to be taken by the system, e.g. generate an alert as described above.

It is understood that according to an exemplary embodiment, a computer readable medium storing a computer program to operate a method according to the foregoing embodiments is provided.

Attention is directed to any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-24. (canceled)

25. A method of analysing energy/utility usage, the method comprising:
receiving (316) data describing energy/utility usage derived from an energy/utility monitor, and
analysing (2-11) the data describing energy/utility usage to generate data representing an energy/utility usage behavioural classification model,
wherein the model includes at least one classification and is useable for determining whether data describing further energy/utility usage fits into a said classification.

26. A method according to claim 25, wherein a said classification specifies an energy/utility usage behaviour pattern indicating when/how an energy/utility user typically uses a certain amount of energy/utility.

27. A method according to claim 25, wherein the step of analysing the data describing energy/utility usage to generate data representing an energy/utility usage behavioural classification model comprises:
identifying (11) at least one energy/utility usage signature of at least respective one energy/utility-consuming device within the data describing energy/utility usage.

28. A method according to claim 27, wherein the step of identifying at least one energy/utility usage signature uses a machine-learning feature selection technique.

29. A method according to claim 27, wherein the step of analysing the data describing energy/utility usage to generate data representing an energy/utility usage behavioural classification model comprises:
analysing the data describing energy/utility usage to identify a behaviour pattern (26) indicating a typical time of day and/or day of week when an energy/utility user uses a said energy/utility-consuming device.

30. A method according to claim 27, wherein the step of analysing the data describing energy/utility usage to generate data representing an energy/utility usage behavioural classification model comprises:
analysing the data describing energy/utility usage to identify a behaviour pattern (26) comprising a sequence indicating use of a first said energy/utility-consuming device followed (or preceded) by use of a second said energy/utility-consuming device.

31. A method according to claim 30, wherein a said sequence specifies a time of day of usage of a said energy/utility-consuming device; a day of week of usage of a said energy/utility-consuming device, and/or a usage combination/sequence of particular ones of the energy/utility-consuming devices over a time period.

32. A method according to claim 31, wherein the step of identifying the behaviour pattern indicating the sequence of usages of certain amounts or types of energy/utility comprises identifying usage of one or more of the energy/utility-consuming devices during a set of temporal observation windows.

33. A method according to claim 27, wherein the model comprises at least one device classifier model representing a said energy/utility-consuming device and at least one behaviour classifier model representing a behaviour/usage pattern of a said energy/utility-consuming device by an energy/utility user, and the method further comprises:
identifying a correlation between usage of a said energy/utility-consuming device represented by data describing further energy/utility usage associated with the energy/utility user and the behaviour/usage pattern of the energy/utility-consuming device by the energy/utility user as represented by the behaviour classifier model.

34. A method according to claim 33, wherein a said device classifier model is created by using the data describing energy/utility usage as training data for a Machine Learning algorithm,
wherein the method uses only a portion of the data describing energy/utility usage following an initial detection/start-up period as the training data to identify a particular said energy-utility-consuming device.

35. A method according to claim 25, including a plurality of said classifications, wherein a first said classification indicates an energy/utility user's normal energy/utility usage pattern and a second said classification indicating the energy/utility user's abnormal energy/utility usage pattern, and
wherein the method includes performing an action depending upon the classification into which data describing further energy/utility usage fits, wherein if the data describing further energy/utility usage fits into the second said classification (or does not fit into the first said classification) then the action comprises requesting the energy/utility user to perform a check-in procedure comprising sending a message to the system, or another user of the system.

36. A method according to claim 35, further comprising generating an alert to another user of the system if the check-in procedure is not performed by the energy/utility user, and further comprising checking if the check-in procedure is fulfilled or cancelled, and if the check-in request is fulfilled or cancelled then the method further comprises using the data describing the further energy/utility usage that resulted in the check-in procedure being requested to update the behavioural classification model.

37. A method according to claim 25, wherein at least the step of analysing the data describing energy/utility usage to generate data representing an energy/utility usage behavioural classification model is performed by a web service, and wherein the web service communicates with one or more external computing device/service using a Representational State Transfer, REST, API.

38. A method according to claim 25 comprising:
connecting (302, 304) a consumer access device to the energy/utility monitor;
receiving (306) signals from the energy/utility monitor at the consumer access device;
generating (308) the data describing energy/utility usage at the consumer access device based on the received signals, and
transferring (310, 312) the data describing energy/utility usage to a remote computing device for the step of analysing.

39. A method according to claim 38, wherein the energy/utility monitor communicates with the consumer access device over a Home Area Network and the energy/utility monitor comprises a smart meter (106), further comprising receiving data describing energy/utility usage from at least one further energy/utility monitor (1802A, 1802C), and analysing the data describing energy/utility usage received from the at least one further energy/utility monitor to generate the data representing the energy/utility usage behavioural classification model.

40. A method according to claim 39, wherein the energy/utility monitor (1802B) and the at least one further energy/utility monitor (1802A, 1802C) are of different types.

41. A method according to claim 40, wherein the energy/utility monitor (1802B) comprises an electricity smart meter, and the at least one further energy/utility monitor (1802A, 1802C) comprise a gas smart meter and/or water smart meter.

42. A computer readable medium storing a computer program to operate a method according to claim 25.

43. A computing device (108) configured to:
receive data describing energy/utility usage derived from an energy/utility monitor, and
analyse the data describing energy/utility usage to generate data representing an energy/utility usage behavioural classification model,
wherein the model includes at least one classification and is useable for determining whether data describing further energy/utility usage fits into a said classification.

44. A consumer access device (106) configured to communicate with an energy/utility monitor (104) and transfer data describing energy/utility usage derived from the energy/utility monitor to a computing device (108) according to claim 43.
